(19) United States
(12) Patent Application Publication
(10) Pub. No.: US 2026/0243404 A1
(43) Pub. Date: Aug. 20, 2026

(54) LASER LIGHT ENGINE WITH OPTICAL FIBER INTEGRATION IN A TRIM PART AND METHODS OF MANUFACTURING THE SAME

(71) Applicant: SRG Global Liria, S.L., Liria (ES)

(72) Inventors: Antonio Escriba, Liria (ES); Sergio Piles, Liria (ES); Javier Molina, Liria (ES); Pablo Baamonde, Liria (ES); Juan Jose Charco, Liria (ES)

(21) Appl. No.: 18/869,858

(22) PCT Filed: Jun. 1, 2023
(86) PCT No.: PCT/EP2023/064701

§ 371 Date: Nov. 27, 2024

(30) Foreign Application Priority Data
Jun. 20, 2022 (ES) P202230544

(51) Int. Cl. F21S 41/29; B60Q 3/64; F21S 41/141; F21S 41/16; F21S 41/24; F21W 104/00; F21Y 103/37

(52) U.S. Cl. CPC F21S 41/29; B60Q 3/64; F21S 41/141; F21S 41/16; F21S 41/24; F21S 2243/00; F21V 2200/15; F21W 2104/00; F21Y 2103/37

(57) ABSTRACT

An illuminated trim component and its method of manufacture include a flexible fiber optic assembly configured to receive and transmit a light beam generated by a light engine therethrough to illuminate the flexible fiber optic assembly, and a trim component having the flexible fiber optic assembly integrated therein such that, when illuminated by the light beam, the flexible fiber optic assembly creates a light accent on the trim component.

### CROSS-REFERENCE TO RELATED APPLICATIONS

The present application claims priority to and the benefit of Spanish Patent Application Number P202230544, filed on Jun. 20, 2022, the disclosure of which as is hereby incorporated by reference herein in its entirety.

### BACKGROUND

### Related Field

The present application generally relates to trim parts, such as automotive trim parts, and, more particularly, to systems and methods for providing a light engine with optical fiber integration in a trim part.

### Related Art

In today's trim components, such as automotive trim components, it is oftentimes desirable to incorporate light accents. One conventional solution for incorporating light accents is to utilize a relatively inexpensive and low power light source in conjunction with a light guide structure that guides/channels the light generated by the light source to create a visible light pattern. These conventional solutions, however, are somewhat limited by both relatively low luminance (e.g., ~2500 candela per square meter, or cd/m²) and any structural limitations of the light guide (e.g., limitations of plastic moldings, packaging space, and the like). Thus, while conventional light accented trim components and their methods of manufacture do accomplish for their most basically intended purpose, there remains a desire for improvement in the relevant art.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of various embodiments of the present disclosure, an illuminated trim component is presented. In one exemplary implementation, the illuminated trim component comprises a flexible fiber optic assembly configured to receive and reflectively transmit a light beam generated by a light engine therethrough to illuminate the flexible fiber optic assembly, and a trim component having the flexible fiber optic assembly integrated therein such that, when illuminated by the light beam, the flexible fiber optic assembly creates a light accent on the trim component.

In some exemplary implementations, the illuminated trim component may further comprise a multi-layer co-extruded profile structure having the flexible fiber optic assembly therein and defining a first set of fixation features for aligning and assembling the multi-layer co-extruded profile structure. In further exemplary implementations, the trim component may also comprise a trim housing defining a second set of complimentary fixation features for aligning and assembling the multi-layer co-extruded profile structure therein. In still additional exemplary implementations, the multi-layer co-extruded profile structure may be a closed structure, such as one having the flexible fiber optic assembly integrated therein. In still other exemplary implementations, the multi-layer extruded profile structure may be an open structure, such that the flexible fiber optic assembly may be separately and/or independently integrated therein.

In certain exemplary implementations, the light engine is a laser light engine configured to generate a laser light beam; but it will be appreciated that the light engine(s) could have other light source configurations (e.g., a plurality of LEDs). In further exemplary implementations, the multi-layer co-extruded profile structure comprises a glass fiber structure to prevent or mitigate elongation. In yet other implementations, the light engine and the flexible fiber optic assembly are configured to generate a luminance greater than that of a conventional light-emitting diode (LED) and light guide based illuminated trim component. In these and still other implementations, the luminance generated by the illuminated trim component is three to four times greater than that of the conventional LED and light guide based illuminated trim component. In at least some exemplary implementations, the luminance generated by the illuminated trim component is approximately 7000 candela (cd/m²) and the light intensity generated by the conventional LED and light guide based illuminated trim component is approximately 2500 cd/m² . In certain other exemplary implementations, the luminance generated by the illuminated trim component may be less than the light intensity generated by conventional configurations, providing a luminance level of around 1400 cd/m²; alternatively a luminance level in a range of about 800 cd/m² to 2000 cd/m².

According to another aspect of various embodiments of the present disclosure, a method of manufacturing an illuminated trim component is presented. In at least one exemplary implementation, the method comprises providing a trim component, forming a flexible fiber optic assembly configured to receive and transmit a light beam generated by a light engine therethrough to illuminate the flexible fiber optic assembly, and forming the illuminated trim component by integrating flexible fiber optic assembly within the trim component such that, when illuminated by the light beam, the flexible fiber optic assembly creates a light accent on the trim component.

In certain exemplary implementations, the method further comprises co-extruding the flexible fiber optic assembly to form a multi-layer co-extruded profile structure having the flexible fiber optic assembly integrated therein and defining a first set of fixation features for aligning and assembling the multi-layer co-extruded profile structure. In further exemplary implementations, the trim component further comprises a trim housing defining a second set of complimentary fixation features, and wherein forming the illuminated trim component further comprises aligning and assembling the multi-layer co-extruded profile structure therein using the first and second sets of complimentary fixation features. In some additional exemplary implementations, the multi-layer co-extruded profile structure is a closed structure having the flexible fiber optic assembly integrated therein. In still further exemplary implementations, the multi-layer extruded profile structure is an open structure such that the flexible fiber optic assembly can be integrated therein.

In various exemplary implementations, the light engine is a laser light engine configured to generate a laser light beam; but it will be appreciated that the light engine(s) could have other light source configurations (e.g., a plurality of LEDs). In certain exemplary implementations, forming the fiber optic assembly comprises forming a glass fiber structure to prevent or mitigate elongation. In additional exemplary implementations, the light engine and the flexible fiber optic assembly are configured to generate a luminance greater than that of a conventional LED and light guide based illuminated trim component. In these and still other exemplary implementations, the luminance generated by the illuminated trim component is three to four times greater than that of the conventional LED and light guide based illuminated trim component. In at least some exemplary implementations, a light intensity generated by the illuminated trim component is approximately 7000 cd/m² and the light intensity generated by the conventional LED and light guide based illuminated trim component is approximately 2500 cd/m². In certain other exemplary implementations, the luminance generated by the illuminated trim component may be less than the light intensity generated by conventional configurations, providing a luminance level of around 1400 cd/m²; alternatively a luminance level in a range of about 800 cd/m² to 2000 cd/m².

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the examples of the present disclosure are intended to be within the scope of the present disclosure. Combinations of the various exemplary implementations listed are also intended to be within the scope of the present disclosure.

### BRIEF DESCRIPTION OF THE DRAWINGS

FIGS. 1A-1B are functional block diagrams of an example illuminated trim component and an example system for its manufacture according to various exemplary embodiments of the present disclosure;

FIGS. 2A-2B are side views of a first example illuminated trim component according to various exemplary embodiments of the present disclosure;

FIGS. 3A-3C are side views of a second example illuminated trim component according to various exemplary implementations of the present disclosure; and

FIG. 4 is a flow diagram of an example method of manufacturing an illuminated trim component according to various exemplary implementations of the present disclosure.

### DETAILED DESCRIPTION OF VARIOUS EMBODIMENTS

As previously discussed, in certain conventional trim components, such as automotive trim components (e.g., front grille assemblies, headlight and/or taillight accents, trunk lid finishers, door handles, etc.), it is desirable to incorporate light accents. One exemplary solution for incorporating light accents is to utilize a relatively inexpensive light source, such as a single or low-powered light emitting diode (LED), in conjunction with a light guide structure that guides and/or directs (i.e., channels) the light generated by the LED to create a visible light pattern. These conventional solutions, however, are somewhat limited by both the relatively low luminance of LEDs (e.g., ~2500 candela per meter squared, or cd/m²) and any structural limitations of the light guide with which they are associated (e.g., limitations of plastic moldings). Thus, while conventional light accented trim components and their methods of manufacture do generally accomplish their fundamental intended purpose, there remains a desire for improved structure, manufacture, and operability.

Accordingly, improved illuminated trim components and their methods of manufacture are presented herein. These illuminated trim components, according to various embodiments, incorporate a flexible fiber optic assembly that receives and transmits a light beam generated by a light engine (e.g., a laser light engine) therethrough to generate greater luminance levels (e.g., ~7500 cd/m²), along with more flexible structural designs. Non-limiting examples of these illuminated trim components include automotive exterior components such as grille assemblies, headlights/taillights, door handles, trunk lid finishers, and automotive interior components such as door handles, infotainment systems, and headliners. It will be appreciated that the systems and methods of the present disclosure are also applicable outside of the automotive area, such as in other passenger transportation (rail, aviation, etc.) and consumer products (furniture, appliances, etc.), listed as mere non-limiting examples of intended uses of the inventive configuration.

Fiber optic technology has traditionally been used in communications to transport light (i.e., information) over long distances with minimal distortion. However, by controlling the operation of a fiber optic assembly (e.g., one or more fiber optic cables) and an associated light engine, it is possible to cause the fiber optic assembly to emit light in a controlled manner. The basic operation of fiber optics in this regard generally involves two concepts: light refraction (when passing between different mediums) and internal reflection (total internal reflectance, or “TIR”). To overcome light unintentionally escaping from an optical fiber core of the fiber optic assembly, a coating or “cladding” having a lower index of reflection (“RI”) is added over a core of the fiber optic assembly. Another coating layer having a lower RI than the cladding is typically applied to the cladding to ensure any stray light that escapes the cladding is reflected back into the core. The fiber optic assembly is then typically sheathed or wrapped in a strong covering (e.g., Kevlar®) and a thick cable jacket for environmental protection.

One fiber optic assembly is also, in certain constructions, capable of comprising multiple cables or distinct cores. One technique for manufacturing fiber optic cables/assemblies is extrusion, in which one or more layers (as described above) are formed by extruding respective materials through a tool or die. The optical fiber core is typically made of plastic fiber or glass fiber. In contrast to a plastic fiber (e.g., an acrylic/polymethyl methacrylate (“PMMA”) or polycarbonate (“PC”) core with a silicone resin cladding), a glass fiber typically consists of a pure glass (silicon dioxide, or “SiO₂”) core with a less pure glass or plastic cladding. While glass fibers are somewhat fragile and prone to breakage, they allow additional light into the system, can transmit a wider spectrum of light wavelengths, exhibit less losses, and can handle extreme environments (temperature, wet, corrosive, etc.) much better compared to plastic fibers.

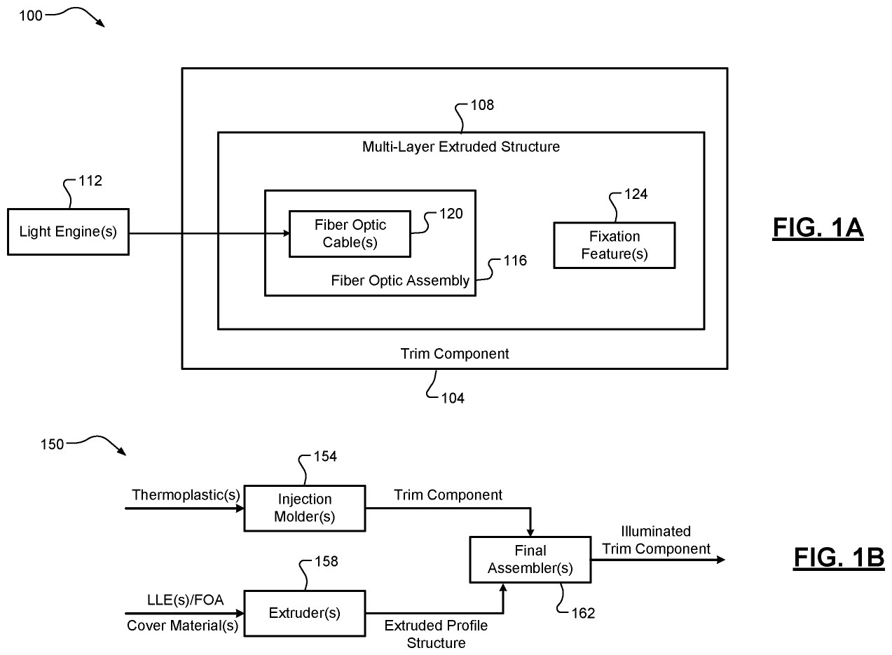

Referring now to FIGS. 1A-1B, functional block diagrams of an exemplary illuminated trim component 100 and an exemplary system 150 for its manufacture according to some embodiments of the present disclosure are illustrated. The illuminated trim component 100 generally comprises a trim component 104 having a multi-layer extruded profile structure 108 therein. This trim component 104 can be formed, for example, using one or more injection molders 154 and desired material(s), such as thermoplastics (PC, PMMA, etc.). The multi-layer extruded profile structure 108 can be formed, for example, using one or more extruders 158. Both separate extrusion processes and co-extrusion processes are possible, as discussed in greater detail below. The last general manufacturing step according to various processes is to integrate the extruded profile structure 108 with the trim component 104 using one or more assemblers 162 (robotic, human, or combinations thereof) to obtain the final illuminated trim component 100. This can include, for example, utilizing set(s) of fixation feature(s) 124 (e.g., interlocking tabs, complimentary threaded holes/screws, and the like) to align and assembly the components with each other.

As illustrated, the extruded profile structure 108 generally comprises a fiber optic assembly 116 that can comprise one or more fiber optic cables 120 integrated therein the structure 108. Each fiber optic cable 120 can be formed of forming a glass fiber structure, and elongation of the fiber optic cable(s) 120 is thereby or proactively prevented or mitigated from elongation (e.g., to prevent breakage/damage). The glass fiber structure(s) can be integrated within other materials as discussed in greater detail above (hence, a “multi-layer” structure). The light engine(s) 112 are configured to generate light beam(s) that reflectively transmit through the fiber optic cable(s) 120 of the fiber optic assembly 116. The light beam(s) can be any desirable color/wavelength. In one exemplary implementation, the light engine(s) 112 are one or more laser light engines configured to generate laser light beam(s), but it will be appreciated that the light engine(s) 112 could have other light source configurations (e.g., a plurality of LEDs). Human eyes are sensitive to light whose wavelength is in the range of about 400 nanometers (nm) to 700 nm, ranging from blue/violet to red. For transmission through the fiber optic cable(s) 120 (e.g., prior to illumination for display/human perception), light in the infrared region (having wavelengths longer than visible light, typically around 850, 1300 and 1550 nm) can be utilized, as the attenuation of the fiber is much less at those wavelengths.

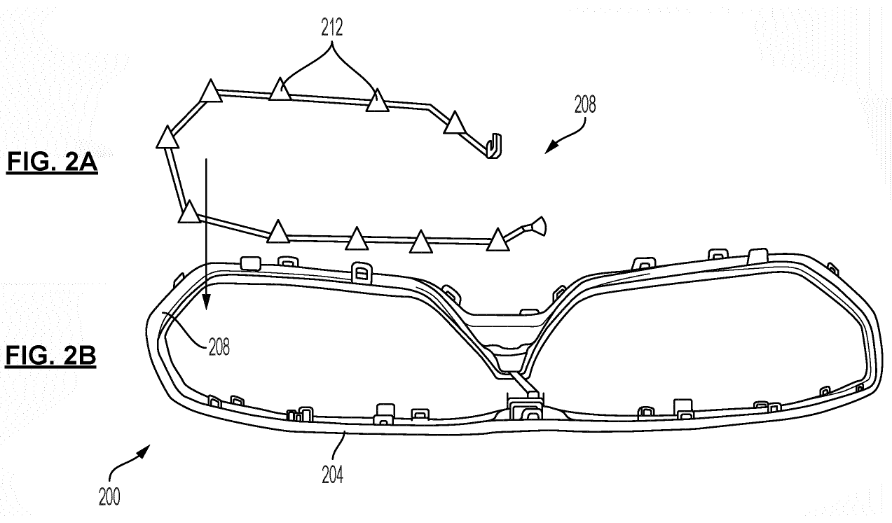

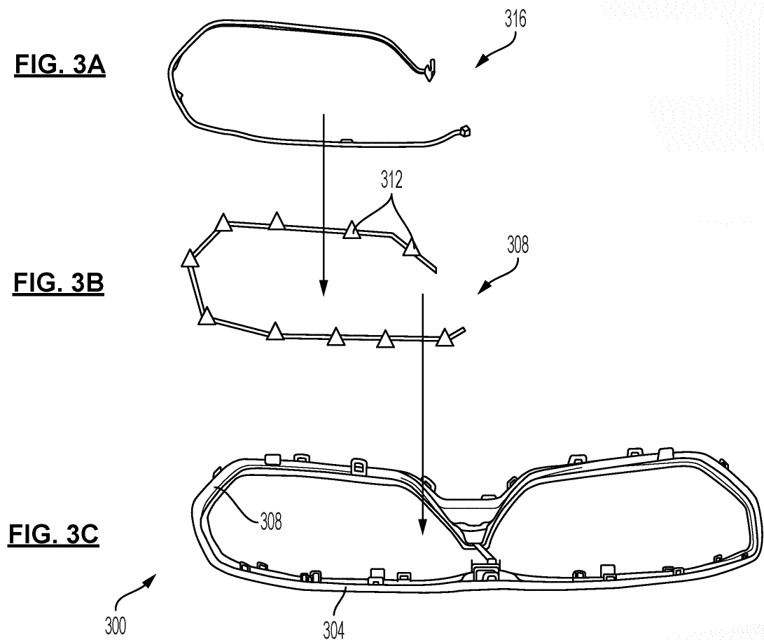

Referring now to FIGS. 2A-2B and 3A-3C, side views of a first exemplary illuminated trim component 200 and a second exemplary illuminated trim component 300 according to some embodiments of the present disclosure are respectively illustrated. In FIGS. 2A-2B, co-extrusion is performed as previously described herein. Co-extrusion can allow, for example, for less processing steps and a more efficient integration of the fiber optic assembly therein. In one step, a co-extrusion process is performed to form a multi-layer co-extruded profile structure 208 having the flexible fiber optic assembly and a set of fixation features 212 for, in another step, aligning and assembling the multi-layer co-extruded profile structure 208 therein the trim component 204 (e.g., with respective fixation features as shown) to form the final illuminated trim component 200. The multi-layer co-extruded profile structure 208 may thus be, in certain embodiments as illustrated, a closed structure that allows for the flexible fiber optic assembly to be easily integrated therein.

In FIGS. 3A-3C, separate extrusion or formation processes are performed as previously described herein. As shown, the trim component further comprises a trim housing defining a first set of fixation features, and wherein forming the illuminated trim component further comprises aligning and assembling a multi-layer extruded profile structure with the trim housing using the first set of fixation features. In one step, an extrusion process is performed to form a fiber optic assembly 316. In another step, another extrusion process is performed to form the multi-layer extruded profile structure 308 having a first set of fixation features 312 for, in another step, aligning and assembling the fiber optic assembly 316 therein. The multi-layer extruded profile structure 308 may thus be an open structure such that fiber optic assembly 316 can be integrated therein. In yet another step, the trim component 304 (e.g., with respective second complimentary fixation feature(s) as shown integrated or part of a trim component, such as a grille assembly/component) receives and aligns the multi-layer extruded profile structure 308 with integrated fiber optic assembly 316 therein to form the final illuminated trim component 300.

Referencing the fiber optic assemblies each described herein-above, it should be further understood that an exemplary advantage thereof is size-related. This is due, in part, to the structure of the assemblies, also as described herein-above, but also intentionally for overcoming of problems with conventional solutions. Limitations of plastic moldings and/or packaging space requires ever-smaller components. To provide an attractive solution not only in luminance, but also size, various embodiments of the fiber optic assemblies have a diameter that is less than three millimeters in size. In certain embodiments, the diameter may be approximately three millimeters; in other embodiments, the diameter may be between 1-2 millimeters; in still other embodiments, the diameter may be less than two or even less than one millimeter.

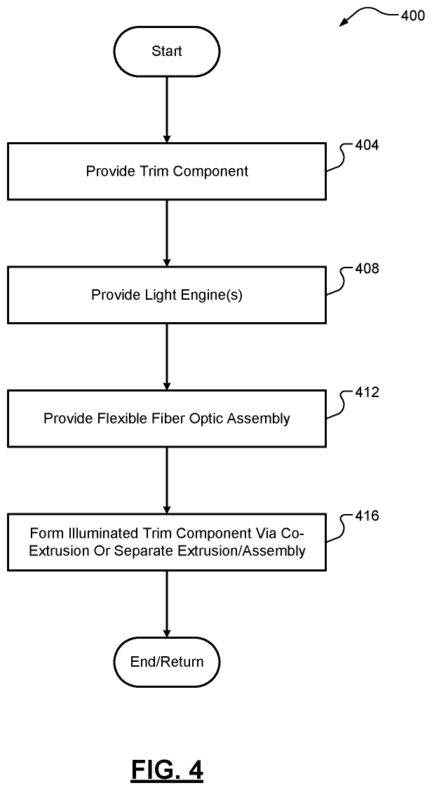

Referring now to FIG. 4, a flow diagram of an exemplary method 400 of manufacturing an illuminated trim component according to some implementations of the present disclosure is illustrated. While the components previously described and illustrated herein could be utilized as part of the method 400, it will be appreciated that the method 400 could be applicable to the formation of any suitable illuminated trim components. At 404, a trim component is formed/provided (e.g., using injection molding). At 408, light engine(s) each configured to generate and emit a light beam is/are provided. As a non-limiting example, a laser light engine(s) configured to generate laser light beam(s) could be used (i.e., a laser+optical fiber-based configuration). In additional embodiments, the light engine(s) may be LED-based (i.e., an LED+optical fiber-based configuration); of course, still other light engine(s) or a combination of types of light engine(s) may be incorporated and utilized, as desirable.

At 412, a flexible fiber optic assembly configured to receive and transmit the light beam(s) therethrough to illuminate the flexible fiber optic assembly. As previously discussed, this manufacturing process 400 can either involve co-extrusion or separate extrusion/formation processes and subsequent alignment/assembly processes. At 416, the illuminated trim component is formed by at least integrating the flexible fiber optic assembly within the trim component such that, when illuminated by the light beam, the flexible fiber optic assembly creates a light accent on the trim component. The method 400 then ends or returns to 404 for one or more additional manufacturing cycles.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. An illuminated trim component, comprising:
a flexible fiber optic assembly configured to receive and transmit therethrough a light beam generated by a light engine so as to illuminate the flexible fiber optic assembly; and
a trim component having the flexible fiber optic assembly integrated therein such that, when illuminated by the light beam, the flexible fiber optic assembly creates a light accent on the trim component.

2. The illuminated trim component of claim 1, further comprising a multi-layer co-extruded profile structure having the flexible fiber optic assembly integrated therein and having a first set of fixation features for aligning and assembling the multi-layer co-extruded profile structure with the flexible fiber optic assembly.

3. The illuminated trim component of claim 2, wherein the trim component further comprises a trim housing having a second set of complimentary fixation features for aligning and assembling the multi-layer co-extruded profile structure therein.

4. The illuminated trim component of claim 3, wherein the multi-layer co-extruded profile structure is a closed structure having the flexible fiber optic assembly integrated therein.

5. The illuminated trim component of claim 3, wherein the multi-layer extruded profile structure is an open structure such that the flexible fiber optic assembly is separate from yet capable of being integrated in the multi-layer extruded profile structure.

6. The illuminated trim component of claim 2, wherein the multi-layer co-extruded profile structure comprises a glass fiber structure to at least one of prevent or mitigate elongation.

7. The illuminated trim component of claim 1, wherein the light engine is a laser light engine configured to generate a laser light beam.

8. The illuminated trim component of claim 1, wherein the light engine is a plurality of light emitting diodes (LEDs).

9. The illuminated trim component of claim 1, wherein the light engine and the flexible fiber optic assembly are configured to generate a luminance within a range of 800 cd/m² to 2000 cd/m².

10. The illuminated trim component of claim 9, wherein the luminance generated is approximately 1400 cd/m².

11. The illuminated trim component of claim 1, wherein the light engine and the flexible fiber optic assembly are configured to generate a luminance level greater than approximately 2500 cd/m².

12. The illuminated trim component of claim 11, wherein the light engine and the flexible fiber optic assembly are configured to generate a luminance level three to four times greater than 2500 cd/m².

13. The illuminated trim component of claim 1, wherein a luminance level generated by the illuminated trim component is approximately 7000 candela per meter squared (cd/m²).

14. The illuminated trim component of claim 1, wherein the fiber optic assembly comprises a fiber optic having a diameter of less than three millimeters.

15. A method of manufacturing an illuminated trim component, the method comprising the steps of:
providing a trim component;
forming a flexible fiber optic assembly configured to receive and transmit a light beam generated by a light engine therethrough to illuminate the flexible fiber optic assembly; and
forming the illuminated trim component by integrating the flexible fiber optic assembly within the trim component such that, when illuminated by the light beam, the flexible fiber optic assembly creates a light accent on the trim component.

16. The method of claim 15, further comprising co-extruding the flexible fiber optic assembly to form a multi-layer co-extruded profile structure having the flexible fiber optic assembly integrated therein and defining a first set of fixation features for aligning and assembling the multi-layer co-extruded profile structure.

17. The method of claim 16, wherein the trim component further comprises a trim housing defining a second set of complimentary fixation features, and wherein forming the illuminated trim component further comprises aligning and assembling the multi-layer co-extruded profile structure therein using the first and second sets of complimentary fixation features.

18. The method of claim 17, wherein the multi-layer co-extruded profile structure is a closed structure having the flexible fiber optic assembly integrated therein.

19. The method of claim 17, wherein the multi-layer extruded profile structure is an open structure such that the flexible fiber optic assembly is separate from but capable of being integrated in the multi-layer extruded profile structure.

20. The method of claim 16, wherein forming the multi-layer co-extruded profile comprises forming a glass fiber structure to at least one of prevent or mitigate elongation.

21. The method of claim 15, wherein the light engine is a laser light engine configured to generate a laser light beam.

22. The method of claim 15, wherein the light engine is a plurality of light emitting diodes (LEDs).

23. The method of claim 15, wherein the light engine and the flexible fiber optic assembly are configured to generate a luminance within a range of 800 cd/m² to 2000 cd/m².

24. The method of claim 23, wherein the luminance generated is approximately 1400 cd/m².

25. The method of claim 15, wherein the light engine and the flexible fiber optic assembly are configured to generate a luminance level greater than approximately 2500 cd/m².

26. The method of claim 25, wherein the light engine and the flexible fiber optic assembly are configured to generate a luminance level three to four times greater than 2500 cd/m².

27. The method of claim 15, wherein the luminance level generated by the illuminated trim component is approximately 7000 candela per meter squared (cd/m²).

28. The illuminated trim component of claim 15, wherein the fiber optic assembly comprises a fiber optic having a diameter of less than three millimeters.
